(19) United States
(12) Patent Application Publication
(10) Pub. No.: US 2003/0063526 A1
(43) Pub. Date: Apr. 3, 2003

(54) High accuracy timepiece

(75) Inventor: Hiroyuki Masaki, Chiba-shi (JP)

Correspondence Address: Bruce L. Adams, Adams & Wilks, 31st Floor, 50 Broadway, New York, NY, 10004, US

(73) Assignee: SEIKO INSTRUMENTS INC.

(21) Appl. No.: 10/233,035

(22) Filed: Aug. 31, 2002

Related U.S. Application Data
(62) Division of application No. 09/426,529, filed on Oct. 26, 1999.

(30) Foreign Application Priority Data
Oct. 30, 1998 (JP) 10-310489

(51) Int. Cl. G04C 9/00

(52) U.S. Cl. 368/187

(57) ABSTRACT

A data input control section inputs a crown state detection signal from a crown state detection section, and determines how a crown is operated. When the operation of selecting a second rate fast/slow data input mode has been performed, the section controls an indication control section to cause the section to give indication for inputting rate fast/slow data. When the operation of inputting rate fast/slow data has been performed with respect to the crown, the rate fast/slow data specified by the operation is outputted to a data storage section.

### BACKGROUND OF THE INVENTION

1 Field of the Invention

The present invention relates to a high-accuracy timepiece whose accuracy adjustment can be made in a complete state and whose accuracy readjustment is not necessary even after a power supply has been temporarily removed. More particularly, the invention is directed to an inexpensive high-accuracy timepiece whose accuracy adjustment can be made by operating a crown or other external input means.

2 Description of the Prior Art

A high-accuracy timepiece guaranteeing an accuracy of 10 seconds a year is now marketed together with an ordinary accuracy timepiece guaranteeing an accuracy of 15 seconds a month. For assembling the high-accuracy timepiece from a movement state into a complete state, one cannot ignore accuracy errors caused by the pressure applied to the crystal oscillator, the floating capacitances fluctuating from one component to another and the like. Therefore, it is necessary to make accuracy adjustments in the complete state. An accuracy adjustment of a conventional high-accuracy timepiece is made in the complete state as follows. A reference signal lasting for a predetermined time period is inputted offline, and the inputted reference signal is compared with an internal signal to thereby measure a deviation from a reference rate, and rate fast/slow data (logic fast/slow data for correcting the deviation from the reference rate) is stored in a writable nonvolatile memory such as an EEPROM. In a digital timepiece disclosed in Japanese Patent Application Laid-Open No. Sho 56-168187, an accuracy adjustment is made by setting rate fast/slow data while operating a button, and storing the data in a volatile memory.

The former conventional technology has addressed the problem that it requires a receiving circuit to be added inside the timepiece and new manufacturing equipment for outputting a reference signal to be provided. Further, a writable nonvolatile memory such as an EEPROM is comparatively expensive among other components of the timepiece, and thus the use of the memory has elevated the cost of the timepiece. On the other hand, the latter conventional technology has addressed the following problems. Since the set rate fast/slow data is erased when a power supply is replaced, the rate must be readjusted. In addition, a button and a liquid crystal display must be provided for inputting the rate fast/slow data, and thus an analog timepiece without a button and a liquid crystal display cannot be applied to a high-accuracy timepiece.

The present invention has been made in view of the aforementioned circumstances, and therefore an object thereof is to provide an inexpensive high-accuracy timepiece which allows rate fast/slow data to be inputted in a complete state and which does not allow the rate fast/slow data to be deleted even when a power supply is replaced.

### SUMMARY OF THE INVENTION

A high-accuracy timepiece according to the present invention allows rate fast/slow data to be inputted from a crown that is already provided on the timepiece in order to allow the rate fast/slow data to be inputted in a complete state even if a receiving circuit and a button are not provided. Further, the high-accuracy timepiece includes data storage means such as an EEPROM which is writable and which allows data stored before a power supply is temporarily removed to remain unchanged even after the power supply has been temporarily removed lest the rate fast/slow data and other data should be deleted when the power supply has been replaced.

Here, in inputting the rate fast/slow data, the day wheel is used not only to determine what operation has been performed by an external part at what timing but also to give indication for inputting the rate fast/slow data and for checking the stored rate fast/slow data. Further, the second hand, the minute hand or the hour hand may be used to do the same in place of the day wheel. Still further, the day wheel may be driven by another motor, or the same motor using an oscillation mechanism.

Further, by allowing two sets of rate fast/slow data for making a rough adjustment and a fine adjustment to be stored in separate means, the timepiece is arranged so as not to lose its accuracy to so large an extent even in the case where the rate fast/slow data for making a fine adjustment has been deleted.

Next, a volatile memory and a power backup capacitor are used jointly as data storage means in place of an expensive writable nonvolatile memory, thereby reducing the cost. Still further, by using power supply removal detection means for detecting removal of a power supply and oscillation control means for controlling oscillation means to stop or resume an oscillation, the power consumption is suppressed.

Further, by using data holding determination means, whether or not data in the data storage means has been held is determined, and the determination result is indicated on indication means.

Here, when the oscillation control means has determined that the power supply has been removed, first, the data storage means stores a plurality of copied data such as the rate fast/slow data. Then, when the operation of resuming an oscillation has been performed by inserting a new power supply, the data holding determination means obtains the plurality of copied data that have been stored and determines whether the data has been held by comparing the obtained data. The determination result is indicated on the indication means.

### BRIEF DESICRIPTION OF THE DRAWINGS

A preferred form of the present invention is illustrated in the accompanying drawings in which:

FIG. 1 is a block diagram showing the construction of and the flow of signals in a high-accuracy timepiece according to a first embodiment of the present invention;

FIG. 2 is a system diagram showing a method of driving a second hand, a minute hand, an hour hand and a day wheel;

FIG. 3 is an explanatory diagram showing an operation method for selecting a second rate fast/slow data input mode and an operation method for inputting second rate fast/slow data;

FIG. 4 is a flowchart showing a second rate fast/slow data input process performed by a data input control section;

FIG. 5 is a system diagram showing a method of driving a second hand, a minute hand, an hour hand and a day wheel of a high-accuracy timepiece according to a second embodiment of the present invention;

FIG. 6 is a diagram showing a method of driving a second hand, a minute hand, an hour hand of a high-accuracy timepiece according to a third embodiment of the present invention;

FIG. 7 is a diagram showing a method of driving a second hand, a minute hand, an hour hand and a day wheel of a high-accuracy timepiece according to a fourth embodiment of the present invention;

FIG. 8 is a block diagram showing the construction of and the flow of signals in a high-accuracy timepiece according to a fifth embodiment of the present invention;

FIG. 9 is a circuit diagram showing an oscillation circuit of an oscillation section shown in FIG. 8.

FIG. 10 is a schematic diagram showing the construction of a power supply removal detection section;

FIG. 11 is a timing chart at the time of a power supply removal detection; and

FIG. 12 is a flowchart showing the operation of an oscillation control section.

### DETAILED DESCRIPTION OF THE PREFERRED EMBODIMENTS

A high-accuracy timepiece of the present invention will now be described in detail with reference to the accompanying drawings in the order of [First Embodiment] to [Fifth Embodiment].

[First Embodiment]

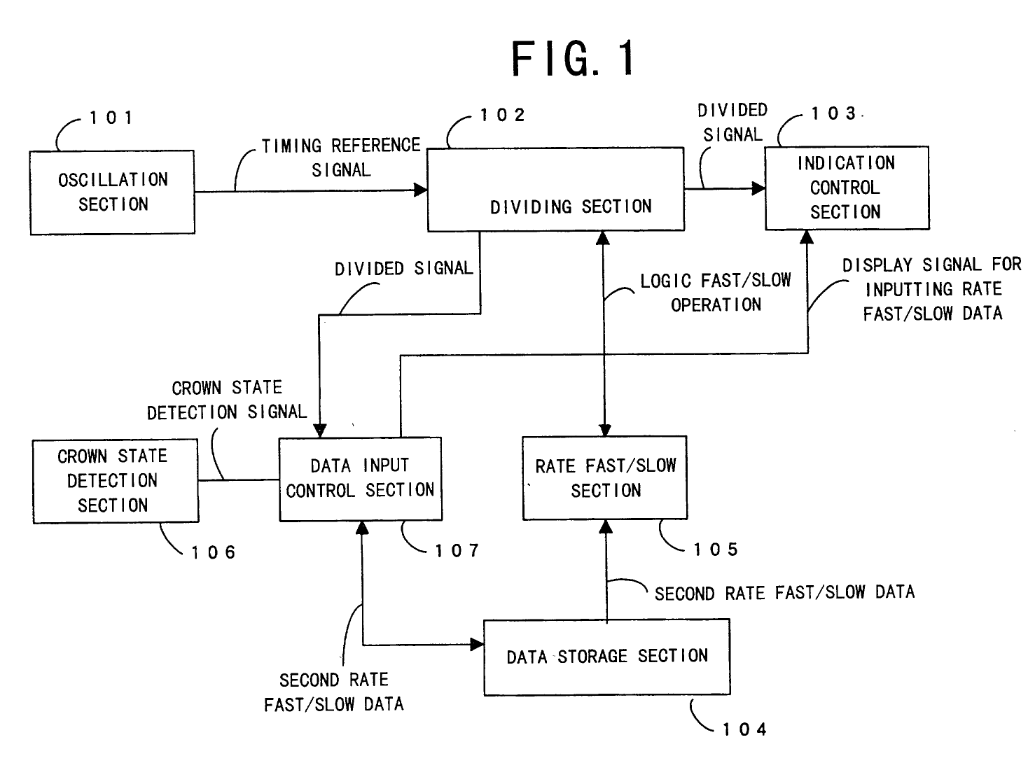

FIG. 1 is a block diagram showing the construction of and the flow of signals in a high-accuracy timepiece according to a first embodiment of the present invention. The high-accuracy timepiece according to the first embodiment includes: an oscillation section 101 for outputting a timing reference signal of approximately 32 kHz; a dividing section 102 for inputting the timing reference signal from the oscillation section 101 and dividing the inputted signal; an indication control section 103 for inputting a divided signal from the dividing section 102 to thereby control a motor; a data storage section 104 having a writable nonvolatile memory for storing second rate fast/slow data (rate fast/slow data for making a finished accuracy fine adjustment in a complete state) and other data; a rate fast/slow section 105 for performing a logic fast/slow operation by controlling the dividing section 102; a crown state detection section 106 for detecting the state of a crown and outputting a crown state detection signal; and a data input control section 107 for inputting the divided signal from the dividing section 102 when the crown state detection signal is inputted from the crown state detection section 106 and outputting the second rate fast/slow data to the data storage section 104.

Here, the rate fast/slow section 105 has a board pattern disconnecting circuit (circuit that stores data by disconnecting a desired one of some data lines which are pulled down inside an IC and which are connected to a power line outside the IC), holds first rate fast/slow data (rate fast/slow data for making a rough accuracy adjustment) using the board pattern disconnecting circuit, inputs second rate fast/slow data from the data storage section 104, and calculates a logic fast/slow amount from the first and second rate fast/slow data.

Note that the high-accuracy timepiece according to the first embodiment is designed so that appropriate second rate fast/slow data is inputted to the data storage section 104 through operation of the crown by the operator after a rate inspection has been made in a complete state at a factory. The appropriate second rate fast/slow data is calculated from the rate inspection result.

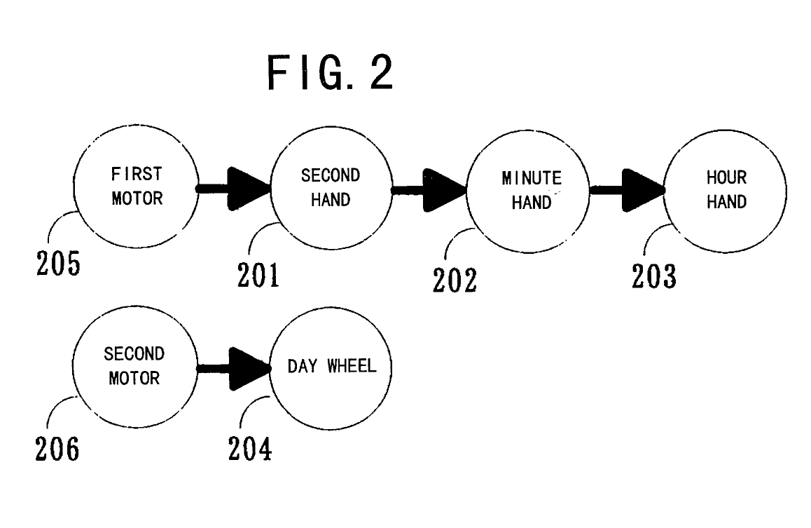

Next, how a second hand, a minute hand, an hour hand and a day wheel are driven by motors will be described with reference to FIG. 2. FIG. 2 is a system diagram showing a method of driving a second hand 201, a minute hand 202, an hour hand 203 and a day wheel 204. The high-accuracy timepiece according to the first embodiment has the second hand 201, the minute hand 202, the hour hand 203 and the day wheel 204, and a first motor 205 for driving the second hand 201, the minute hand 202 and the hour hand 203, and a second motor 206 for driving the day wheel 204. Here, the second motor 206 drives the day wheel 204 to thereby give indication for inputting the second rate fast/slow data.

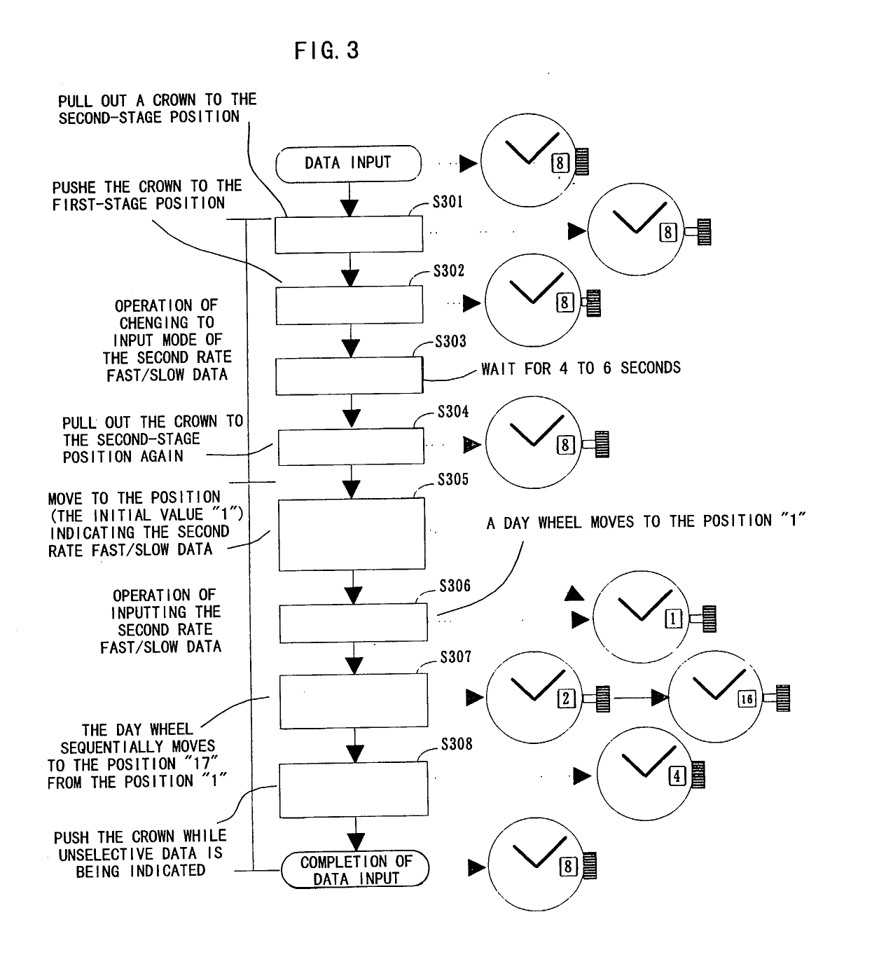

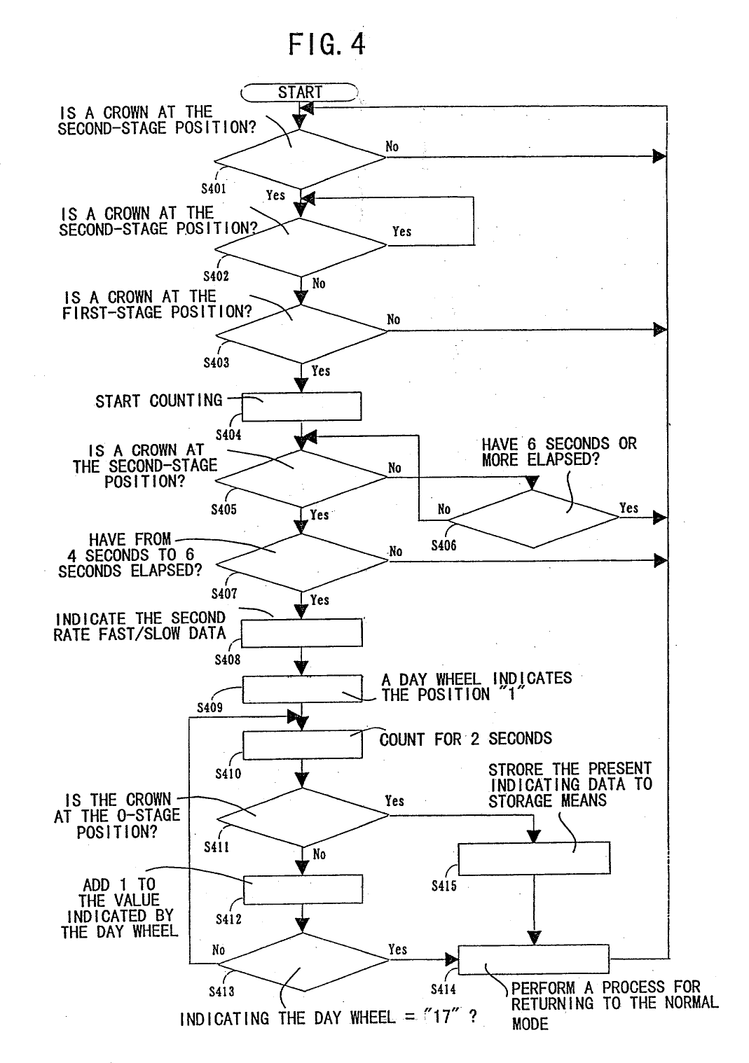

Next, how the second rate fast/slow data is inputted will be described in brief with reference to FIG. 3 and in detail with reference to FIG. 4. FIG. 3 is an explanatory diagram showing the operation of selecting a second rate fast/slow data input mode and a method of inputting the second rate fast/slow data. First of all, the operator pulls out the crown to the second-stage position (step S301),pushes the crown to the first-stage position (step S302), waits for 4 to 6 seconds (step S303), and pulls out the crown to the second-stage position again (step S304). As a result of this operation, the second rate fast/slow data input mode is selected in the high-accuracy timepiece according to the first embodiment.

Successively, the day wheel 204 moves to the position indicating the second rate fast/slow data at this time (if the second rate fast/slow data has never been inputted up to this time, the initial value 1 is set as the second-rate fast/slow data) (step S305). Then, the day wheel 204 moves to the position 1 (step S306), and sequentially moves to the position 17 from the position 2 (step S307). Here, the values 1 to 17 indicated by the day wheel are the values of the second rate fast/slow data. When the operator pushes the crown to the 0-stage position as the final step S307 while the appropriate second rate fast/slow data is being indicated (step S308), the operation of inputting the second rate fast/slow data is complete.

Here, to prevent the operator from erroneously changing the appropriate second rate fast/slow data due to unintended switchin over to the second rate fast/slow data input mode, the operation of selecting the second rate fast/slow data input mode is devised, e.g., so as to include the skilled operation of pushing the crown from the second to the first stage (step S302).

FIG. 4 is a flowchart showing a second rate fast/slow data input process performed by the data input control section 107 according to the first embodiment. First, in step S401, the data input control section 107 waits until it receives from the crown state detection section 106 a crown state detection signal indicating that the crown is at the second-stage position. When receiving the crown state detection signal indicating that the crown is at the second-stage position, the section 107 goes to step S402. In step S402, the section 107 waits until the crown position changes, and when the crown position has changed, the section 107 goes to step 403.

In step S403, the section 107 determines whether or not the crown is at the first-stage position. If the crown is not at the first-stage position, the section 107 returns to step S401, whereas if the crown is at the first-stage position, the section 107 starts counting the divided signal from the dividing section (step S404), and then goes to step S405.

In step S405, the section 107 determines whether or not the crown is at the second-stage position. If the crown is not set at the second-stage position, the section 107 goes to step S406. In step S406, the section 107 determines whether or not 6 seconds or more have elapsed from the divided signal count start. If 6 seconds or more have elapsed from the divided signal count start, the section 107 stops counting the divided signal, and returns to step S401. If 6 seconds or more have not elapsed, the section 107 returns to step S405. If the crown is at the second-stage position in step S405, the section 107 goes to step S407.

In step S407, the section 107 determines whether or not a time interval between the divided signal count start and the present is equal to or greater than 4 seconds and smaller than 6 seconds. If the time elapsed from the divided signal count start is less than 4 seconds or is 6 seconds or more, the section 107 stops counting the divided signal and returns to step S401. If the time elapsed from the divided signal count start is equal to or greater than 4 seconds and smaller than 6 seconds, the section 107 stops counting the divided signal, and inputs the second rate fast/slow data stored in the data storage section 104 (if the second rate fast/slow data has never been inputted up to this time, the initial value 1 is stored as the second rate fast/slow data). Then, the section 107 moves the day wheel 204 to the position indicating the value of the second rate fast/slow data through the indication control section 103 by controlling the second motor 206 (step S408), and moves the day wheel 204 to the position 1 (step S409). Then, the section 107 counts the divided signal for 2 seconds (step S410), and goes to step S411.

In step S411, the section 107 determines whether or not the crown is at the 0-stage position. If the crown is not at the 0-stage position, the section 107 moves the day wheel 204 to the position indicating the value obtained by adding 1 to the value indicated by the day wheel 204 (step S412), and goes to step S413. In step S413, the section 107 determines whether or not the day wheel 204 indicates 17. If the day wheel 204 does not indicate 17, the section 107 returns to step S410. If the day wheel 204 indicates 17 in step S413, the section 107 performs a process for returning to the normal mode (step S414) and then returns to step S401. If the crown is at the 0-stage position in step S411, the section 107 goes to step S415. Instep S415, the section 107 outputs the value indicated by the day wheel 204 at this time to the data storage section 104 as the second rate fast/slow data, goes to step S414, and then returns to step S401.

As described above, according to the first embodiment, the second rate fast/slow data can be inputted in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the stored second rate fast/slow data is indicated, the stored second rate fast/slow data can be checked.

Still further, while the first embodiment allows a total of 16 sets of second rate fast/slow data to be inputted, the first embodiment may also be designed so that it allows a total of 17 to 31 sets of second rate fast/slow data to be inputted.

[Second Embodiment]

The high-accuracy timepiece according to the first embodiment has two motors, the first motor for driving the second hand, the minute hand and the hour hand, and the second motor for driving the day wheel, and causes the first motor to drive the day wheel to give indication for inputting the second rate fast/slow data when the second rate fast/slow data input process is performed. A similar effect can be provided by using a single motor.

Here, a high-accuracy timepiece according to a second embodiment has only one motor, and allows the second rate fast/slow data to be inputted by externally operating the crown in the complete state.

Since the basic construction of the second embodiment is the same as that of the first embodiment, only a method of driving the second hand, the minute hand, the hour hand and the day wheel, which is different, will herein be described.

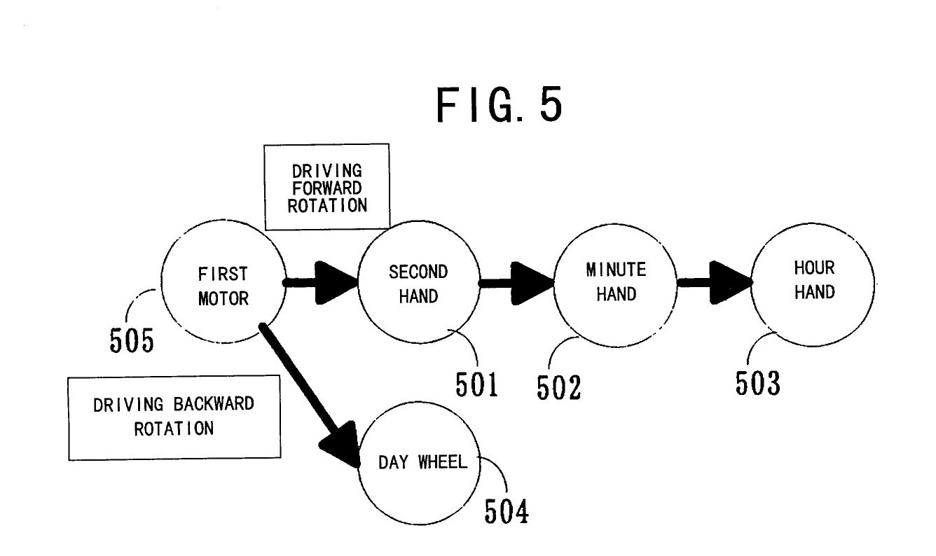

FIG. 5 is a system diagram showing a method of driving a second hand 501, a minute hand 502, an hour hand 503 and a day wheel 504 of a high-accuracy timepiece according to the second embodiment of the present invention. The high-accuracy timepiece according to the second embodiment has the second hand 501, the minute hand 502, the hour hand 503, the day wheel 504, a swing gear and a first motor 505. Here, when the first motor 505 rotates forward, the swing gear meshes with a gear train of a second hand wheel, and the first motor 505 then drives the second hand 501, the minute hand 502 and the hour hand 503 through the swing gear. When the first motor 505 rotates backward, the swing gear oscillates to mesh with a gear train of the day wheel, and the first motor 505 then drives the day wheel 504 through the swing gear. In order to give indication for inputting the second rate fast/slow data, the first motor 505 rotates backward to drive the day wheel 504 through the swing gear.

As described above, according to the second embodiment, the second rate fast/slow data can be inputted in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the stored second rate fast/slow data is indicated, the stored second rate fast/slow data can be checked.

[Third Embodiment]

While the day wheel is used to give indication for inputting the second rate fast/slow data in the first and second embodiments, a similar effect can be provided without the day wheel.

Here, a high-accuracy timepiece according to a third embodiment has a second hand, a minute hand and an hour hand, and allows the second rate fast/slow data to be inputted by externally operating the crown in the complete state.

Since the basic construction of the third embodiment is the same as that of the first embodiment, only a method of driving the second hand, the minute hand and the hour hand, which is different, will herein be described.

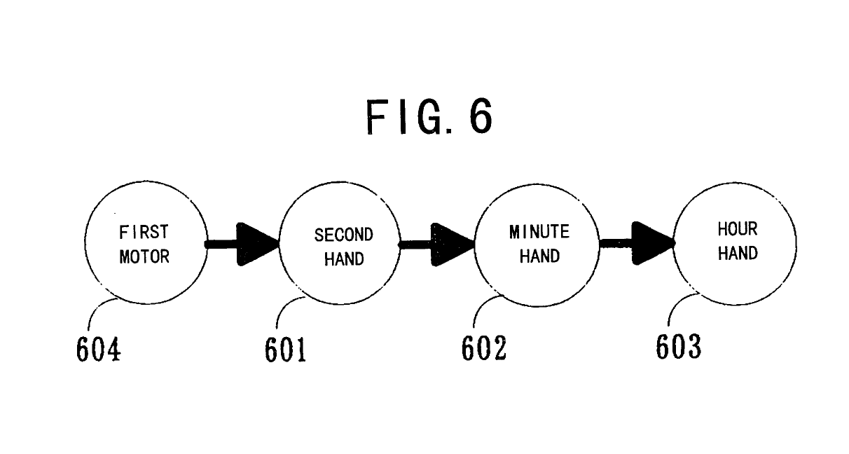

FIG. 6 is a diagram showing a method of driving a second hand 601, a minute hand 602 and an hour hand 603 of a high-accuracy timepiece according to the third embodiment of the present invention. The high-accuracy timepiece according to the third embodiment has the second hand 601, the minute hand 602, the hour hand 603 and a first motor 604 for driving the second hand 601, the minute hand 602 and the hour hand 603. Here, the first motor 604 drives the second hand 601 to give indication for inputting the second rate fast/slow data. Therefore, when the rate fast/slow data input process is performed, the second hand 601 indicates the values 1 to 17 instead of the day wheel.

As described above, according to the third embodiment, the second rate fast/slow data can be inputted in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the stored second rate fast/slow data is indicated, the stored second rate fast/slow data can be checked.

Further, while the third embodiment allows a total of 16 sets of second rate fast/slow data to be inputted, the third embodiment may also be designed so that it allows a total of 17 to 60 sets of second rate fast/slow data to be inputted.

[Fourth Embodiment]

Since the basic construction of a fourth embodiment is the same as that of the first embodiment, only a method of driving a second hand, a minute hand, an hour hand and a day wheel, which is different, will herein be described.

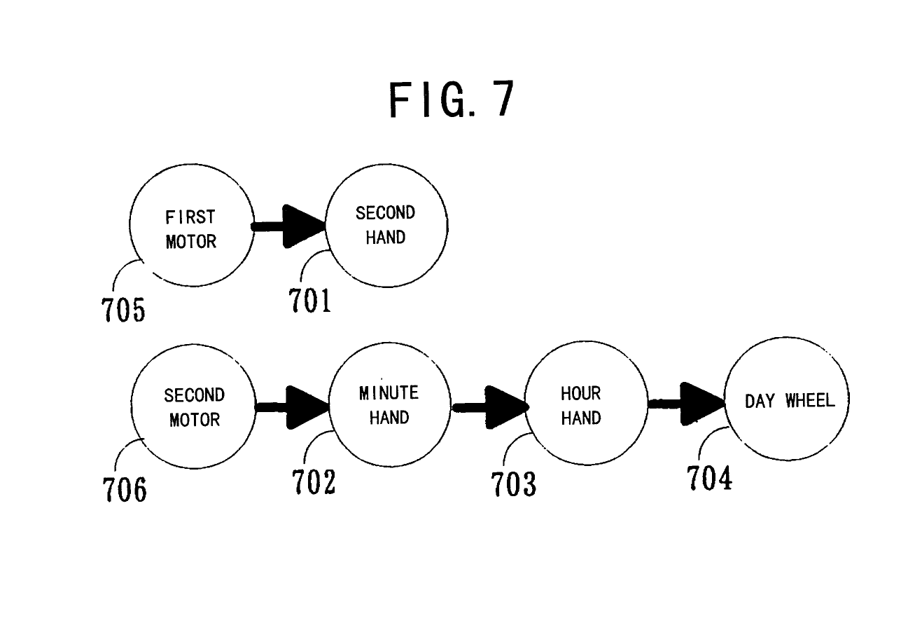

FIG. 7 is a diagram showing a method of driving a second hand 701, a minute hand 702, an hour hand 703 and a day wheel 704 of a high-accuracy timepiece according to the fourth embodiment of the present invention. The high-accuracy timepiece according to the fourth embodiment has the second hand 701, the minute hand 702, the hour hand 703, the day wheel 704, a first motor 705 for driving the second hand 701, and a second motor 706 for driving the minute hand 702, the hour hand 703 and the day wheel 704. Here, the second motor 706 drives the minute hand 702 to give indication for inputting the second rate fast/slow data. Therefore, when the second rate fast/slow data input process is performed, the minute hand 702 indicates the values 1 to 17 instead of the day wheel.

According to the fourth embodiment, the second rate fast/slow data can be inputted in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the stored second rate fast/slow data is indicated, the stored second rate fast/slow data can be checked.

Further, while the fourth embodiment allows a total of 16 sets of second rate fast/slow data to be inputted, the fourth embodiment may also be designed so that it allows a total of 17 to 60 sets of second rate fast/slow data to be inputted.

[Fifth Embodiment]

While the first to fourth embodiments have a writable nonvolatile memory for storing the second rate fast/slow data, a similar effect can be provided without a writable nonvolatile memory.

Here, a high-accuracy timepiece according to a fifth embodiment has a volatile memory and a power backup capacitor in the data storage section, and allows the second rate fast/slow data to be inputted by externally operating the crown in the complete state.

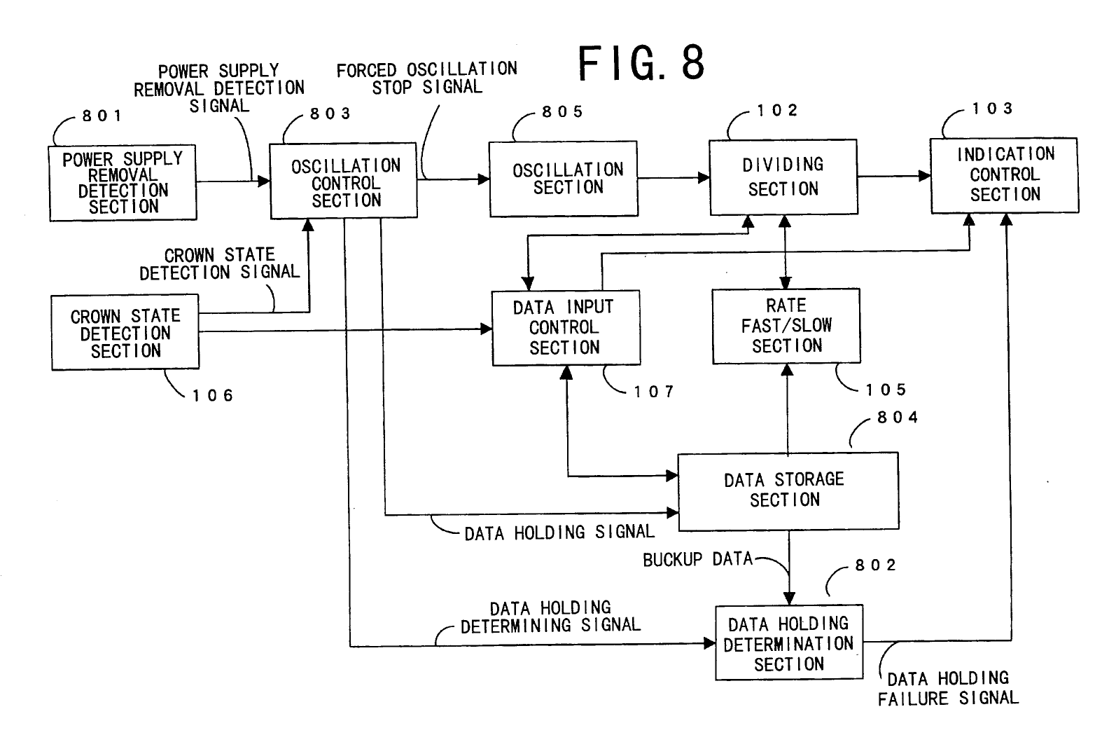

FIG. 8 is a block diagram showing the construction of and the flow of signals in a high-accuracy timepiece according to the fifth embodiment of the present invention. Since the basic construction of the fifth embodiment is the same as that of the first embodiment, only different portions will herein be described while omitting a description of the same parts and components which are denoted by the same reference numerals.

In addition to the construction of the first embodiment shown in FIG. 1, a high-accuracy timepiece according to the fifth embodiment has a power supply removal detection section 801 for detecting removal of a power supply and outputting a power supply removal detection signal, a data holding determination section 802 for inputting a plurality of copied data of second rate fast/slow data and other data from a data storage section 804 to determine whether or not the data in the data storage section has been held, and an oscillation control section 803 for outputting a forced oscillation stop signal to an oscillation section 805. The forced oscillation stop signal instructs the section 805 to stop oscillating.

Further, the data storage section 804 has, instead of a writable nonvolatile memory, a volatile memory and a power backup capacitor for supplying power to the volatile memory when the power supply is temporarily removed. Note that the data holding determination section 802 outputs a data holding failure signal to the indication control section 103 when determining that the data holding operation has failed. The data holding failure signal instructs the indication control section 103 to indicate the data holding failure.

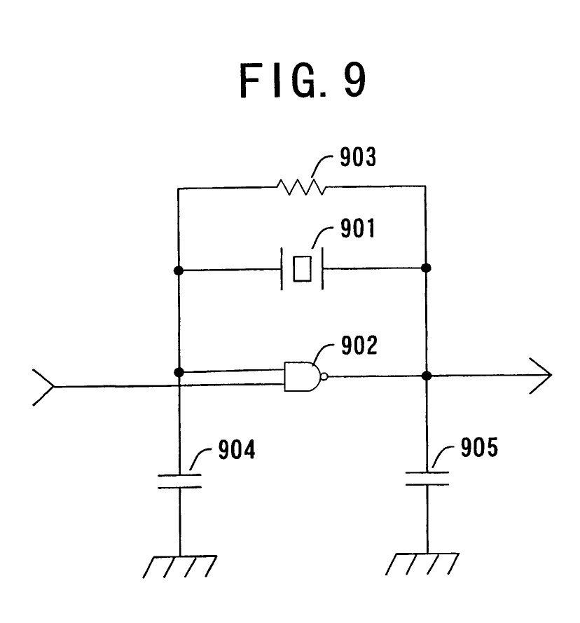

FIG. 9 is a circuit diagram showing an oscillation circuit of the oscillation section 805 according to the fifth embodiment. The oscillation circuit according to the fifth embodiment comprises a crystal oscillator 901, a NAND circuit 902, a resistor 903 and capacitors 904 and 905. When inputting a negative logic signal, the oscillation circuit stops oscillating, and when inputting a positive logic signal, it starts oscillating.

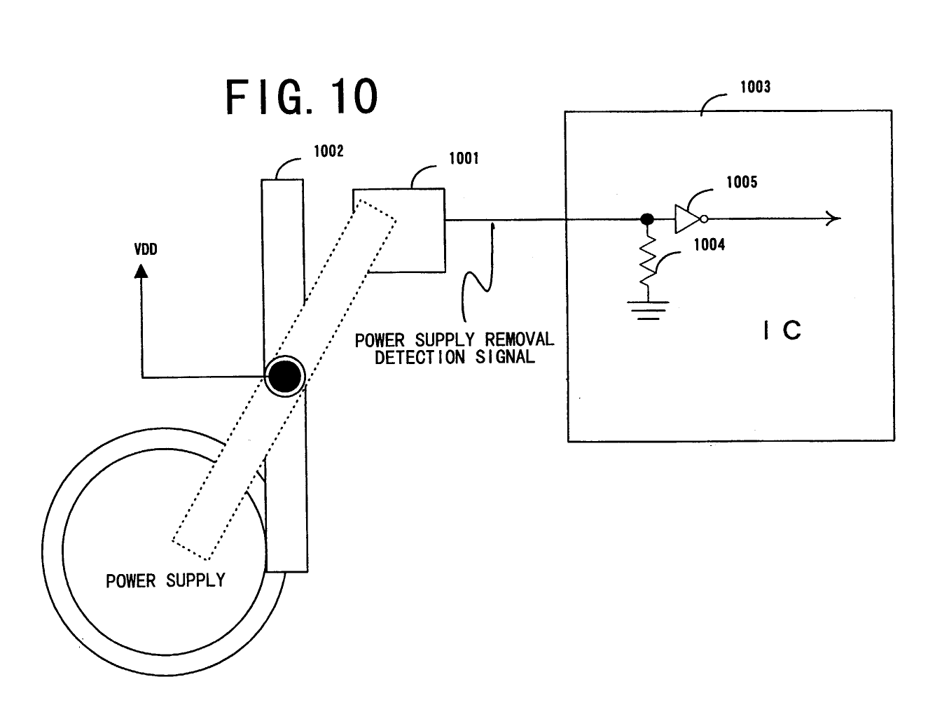

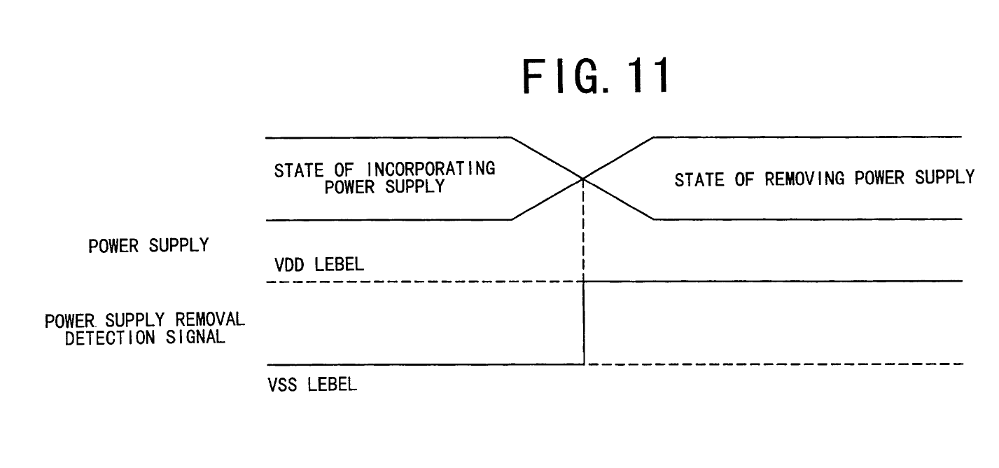

FIG. 10 is a schematic diagram showing the construction of the power supply removal detection section 801, and FIG. 11 is a timing chart at the time of a power supply removal detection. The power supply removal detection section 801 according to the fifth embodiment has a metal terminal 1001, and a metal plate 1002 whose potential is VDD and which moves to come in contact with the metal terminal 1001 when the power supply has been removed. Further, the oscillation control section 803 has an IC 1003. The IC 1003 incorporates therein a resistor 1004 whose potential is VSS at one end thereof, and a NOT circuit 1005. The IC 1003 monitors a power supply removal detection signal (the potential of the metal terminal 1001). When the power is turned on, the metal plate 1002 is distant from the terminal 1001, and thus the potential of the power supply removal detection signal is VSS, whereas when the power has been removed, the metal plate 1002 is in contact with the terminal 1001, and thus the potential of the power supply removal detection signal is VDD.

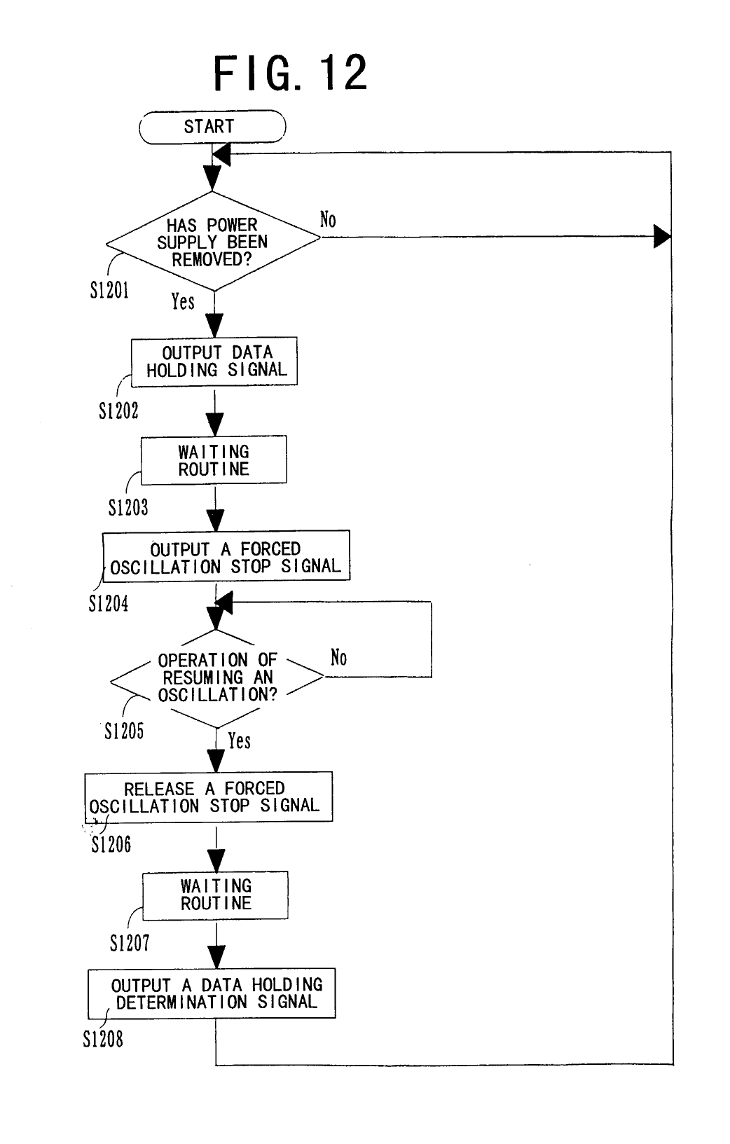

In the aforementioned construction, a process performed by the oscillation control section 803 at the time of a temporary removal of the power supply and after the temporary removal of the power supply will be described. FIG. 12 is a flowchart showing the operation of the oscillation control section 803.

First of all, the oscillation control section 803 waits until it receives from the power supply removal detection section 801 a power supply removal detection signal indicating that the power supply has been removed (step S1201). When the section 803 receives from the power supply removal detection section 801 the power supply removal detection signal indicating that the power supply has been removed in step S1201, the section 803 outputs to the data storage section 104 a data holding signal for instructing the section 104 to store a plurality of copied data of the second rate fast/slow data and other data (step S1202), waits for a given time (step S1203), and outputs a forced oscillation stop signal to the oscillation section 101 to cause the section 101 to stop oscillating (step S1204).

Next, the oscillation control section 803 determines how the crown is operated by inputting a crown state detection signal from the crown state detection section 106, and then waits until the operation of resuming an oscillation for the crown is performed (step S1205). When the operation of resuming an oscillation is performed for the crown in step S1205, the section 803 releases the forced oscillation stop signal to the oscillation section 101 to cause the section 101 to resume the oscillation (step S1206), waits for a given time (step S1207), outputs a data holding determination signal to the data holding determination section 802 and returns to step S1201 (step S1208).

As described above, according to the fifth embodiment, the second rate fast/slow data can be inputted in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, an inexpensive volatile memory and a power backup capacitor are used in place of an expensive writable nonvolatile memory. Therefore, the cost of the high-accuracy timepiece can be kept down. Still further, since the stored second rate fast/slow data is indicated, the stored second rate fast/slow data can be checked.

As described in the foregoing, the high-accuracy timepiece according to the present invention can input rate fast/slow data in the complete state through operation of the crown by the operator. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the rate fast/slow data is inputted by operating the crown, there is no need to provide a button.

Further, the high-accuracy timepiece according to the present invention can input rate fast/slow data in the complete state by causing the operator to operate external input means such as a button. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down. Further, since the rate fast/slow data and other data are stored in a writable nonvolatile memory or other data storage means, there is no need to set the data again after the battery has been replaced.

Further, the high-accuracy timepiece according to the present invention can input rate fast/slow data by operating the crown. Therefore, there is no need to provide a button.

Further, the high-accuracy timepiece according to the present invention can input rate fast/slow data in the complete state by causing the operator to operate external input means. Therefore, it is not necessary to additionally provide a receiving circuit inside the high-accuracy timepiece nor is it necessary to provide new manufacturing equipment for outputting a reference signal, and thus the cost of the high-accuracy timepiece can be kept down.

Further, the high-accuracy timepiece according to the present invention determines what operation is performed by external means at which timing. Therefore, the operation of selecting the rate fast/slow data input mode is so complicated as to include also a timing requirement. As a result, the probability of accidental switching over to the rate fast/slow data input mode by the user is reduced.

Further, since the high-accuracy timepiece according to the present invention indicates stored rate fast/slow data, the operator can be informed of the stored rate fast/slow data.

Further, the high-accuracy timepiece according to the present invention holds the first rate fast/slow data for making a rough adjustment independently of the second rate fast/slow data for making a fine adjustment. Therefore, should the second rate fast/slow data be lost, there is no likelihood that the timepiece will go wrong to so large an extent in terms of accuracy.

Further, since the high-accuracy timepiece according to the present invention gives indication for the rate fast/slow data, the rate fast/slow data can be inputted easily.

Further, the high-accuracy timepiece according to the present invention gives indication for inputting the rate fast/slow data using the day wheel. Therefore, there is no need to provide a liquid crystal display screen.

Further, the high-accuracy timepiece according to the present invention gives indication for inputting the rate fast/slowdata using the second hand. Therefore, there is no need to provide a liquid crystal display screen.

Further, the high-accuracy timepiece according to the present invention gives indication for inputting the rate fast/slow data using the minute hand. Therefore, there is no need to provide a liquid crystal display screen.

Further, the high-accuracy timepiece according to the present invention gives indication for inputting the rate fast/slow data using the hour hand. Therefore, there is no need to provide a liquid crystal display screen.

Further, the high-accuracy timepiece according to the present invention has a second motor for driving the day wheel in addition to a first motor for driving the second hand, the minute hand and the hour hand. Therefore, indication for inputting the rate fast/slow data can be given by the day wheel.

Further, the high-accuracy timepiece according to the present invention includes a single motor which drives the second hand, the minute hand and the hour hand when rotating forward and which drives the day wheel when rotating backward through a swing gear. Therefore, indication for inputting the rate fast/slow data can be given by the day wheel.

Further, the high-accuracy timepiece according to the present invention includes a single motor for driving the second hand, the minute hand and the hour hand. Therefore, indication for inputting the rate fast/slow data can be given by the second hand.

Further, the high-accuracy timepiece according to the present invention includes a first motor for driving the second hand and a second motor for driving the minute hand, the hour hand and the day wheel. Therefore, indication for inputting the rate fast/slow data can be given by the minute hand.

Further, the high-accuracy timepiece according to the present invention includes a first motor for driving the second hand and the minute hand and a second motor for driving the hour hand and the day wheel. Therefore, indication for inputting the rate fast/slow data can be given by the hour hand.

Further, the high-accuracy timepiece according to the present invention has an inexpensive volatile memory and a power backup capacitor in place of an expensive writable nonvolatile memory. Therefore, the cost of the high-accuracy timepiece can be kept down.

Further, the high-accuracy timepiece according to the present invention determines whether or not data in the data storage means has been held and indicates the determination result. Therefore, whether or not the data has been held can be checked.

Further, the high-accuracy timepiece according to the present invention determines whether or not data in the data storage means has been held by an appropriate method and indicates the determination result. Therefore, whether or not the data has been held can be checked.

Further, the high-accuracy timepiece according to the present invention resumes an oscillation by an external operation. Therefore, the problem of chattering at the power supply caused in the case where an oscillation is resumed detection of the power supply inserted can be avoided.

Further, the high-accuracy timepiece according to the present invention has an inexpensive volatile memory and a power backup capacitor in place of an expensive writable nonvolatile memory. Therefore, the cost of the high-accuracy timepiece can be kept down.

Further, the high-accuracy timepiece according to the present invention determines whether or not data in the data storage means has been held and indicates the determination result. Therefore, whether or not the data has been held can be checked.

Further, the high-accuracy timepiece according to the present invention determines whether or not data in the data storage means has been held by an appropriate method and indicates the determination result. Therefore, whether or not the data has been held can be checked.

Further, the high-accuracy timepiece according to the present invention resumes an oscillation by an external operation. Therefore, the problem of chattering at the power supply caused in the case where an oscillation is resumed upon detection of the power supply inserted can be avoided.

What is claimed is:

1. A high-accuracy timepiece having writable data storage means and inputting rate fast/slow data in a complete state, characterized by comprising:
a crown;
a state detection means for detecting a state of said crown and outputting a state detection signal; and
a data input control means for inputting the state detection signal from said state detection means, determining what operation has been performed by an external part, and, when an operation for inputting the rate fast/slow data has been performed, causing said data storage means to store the rate fast/slow data specified by the operation.

2. A high-accuracy timepiece inputting rate fast/slow data in a complete state, characterized by comprising:
a data storage means which is writable and which holds data stored before a power supply is temporarily removed even after the power supply has been temporarily removed;
an external input means for externally performing an operation of inputting the rate fast/slow data;
a state detection means for detecting a state of said external input means and outputting a state detection signal; and
a data input control means for inputting the state detection signal from said state detection means, determining what operation has been performed by said external input means, and, when an operation for inputting the rate fast/slow data has been performed, causing said data storage means to store the rate fast/slow data specified by the operation.

3. A high-accuracy timepiece according to claim 2, characterized in that said external input means is a crown.

4. A high-accuracy timepiece according to claim 1, characterized by further comprising:
an oscillation means for outputting a timing reference signal;
a dividing means for inputting the timing reference signal from said oscillation means and dividing the timing reference signal;
an indication means for indicating timing information corresponding to an output of said dividing means; and
a rate fast/slow means for inputting the rate fast/slow data from said data storage means, calculating a logic fast/slow amount, and controlling said dividing means so as to perform a logic fast/slow operation.

5. A high-accuracy timepiece according to claim 4, characterized in that said data input control means inputs the state detection signal from said state detection means and the divided signal from said dividing means, and determines what operation has been performed at what timing by the external part.

6. A high-accuracy timepiece according to claim 4, characterized in that said indication means indicates the rate fast/slow data stored in said data storage means.

7. A high-accuracy timepiece according to claim 4, in which:
said rate fast/slow means allows data to be inputted in a state preceding a complete state, has holding means for holding stored data even after the power supply has been temporarily removed, and holds first rate fast/slow data which is rate fast/slow data for making a rough adjustment;
said data storage means stores second rate fast/slow data, which is rate fast/slow data for making a finished accuracy fine adjustment; and
said rate fast/slow means obtains the second rate fast/slow data from said data storage means, and calculates a logic fast/slow amount from the first rate fast/slow data and the second rate fast/slow data, and
controls said dividing means so as to perform a logic fast/slot operation based on the logic fast/slow amount.

8. A high-accuracy timepiece according to claim 4, characterized in that said indication means gives indication for inputting the rate fast/slow data upon an inputting operation of the rate fast/slow data.

9. A high-accuracy timepiece according to claim 4, further comprising a day wheel, characterized in that said day wheel is used to give indication for inputting the rate fast/slow data upon an inputting operation of the rate fast/slow data.

10. A high-accuracy timepiece according to claim 4, further comprising a second hand, characterized in that said second hand is used to give indication for inputting the rate fast/slow data upon an inputting operation of the rate fast/slow data.

11. A high-accuracy timepiece according to claim 4, further comprising a minute hand, characterized in that said minute hand is used to give indication for inputting the rate fast/slow data upon an inputting operation of the rate fast/slow data.

12. A high-accuracy timepiece according to claim 4, further comprising an hour hand, characterized in that said hour hand is used to give indication for inputting the rate fast/slow data upon an inputting operation of the rate fast/slow data.

13. A high-accuracy timepiece according to claim 4, further comprising:
a second hand, a minute hand, an hour hand and a day wheel;
a first motor for driving said second hand, said minute hand and said hour hand; and
a second motor for driving said day wheel, characterized in that
by causing said second motor to drive said day wheel, said day wheel gives indication for inputting the rate fast/slow data.

14. A high-accuracy timepiece according to claim 4, further comprising a second hand, a minute hand, an hour hand, a day wheel, a swing gear for oscillating so as to mesh with either a gear train of a second hand wheel or a gear train of said day wheel depending on the direction of rotation of a motor, and said motor for driving said swing gear, characterized in that:
when said motor rotates forward, said swing gear meshes with the gear train of said second hand wheel, and said motor drives said second hand, said minute hand and said hour hand through said swing gear;
when said motor rotates backward, said swing gear oscillates to mesh with the gear train of said day wheel, and said motor drives said day-wheel through said swing gear; and
by rotating said motor backward to drive said day wheel through said swing gear, said day wheel gives indication for inputting the rate fast/slow data.

15. A high-accuracy timepiece according to claim 4, further comprising:
a second hand, a minute hand, an hour hand; and
a single motor for driving said second hand, said minute hand and said hour hand, characterized in that
by causing said motor to drive said second hand, said second hand gives indication for inputting the rate fast/slow data.

16. A high-accuracy timepiece according to claim 4, further comprising:
a second hand, a minute hand, an hour hand and a day wheel;
a first motor for driving said second hand; and
a second motor for driving said minute hand, said hour hand and said day wheel, characterized in that
by causing said second motor to drive said minute hand, said minute hand gives indication for inputting the rate fast/slow data.

17. A high-accuracy timepiece according to claim 4, further comprising:
a second hand, a minute hand, an hour hand and a day wheel;
a first motor for driving said second hand and said minute hand; and
a second motor for driving said hour hand and said day wheel, characterized in that
by causing said second motor to drive said hour hand, said hour hand gives indication for inputting the rate fast/slow data.

18. A high-adcuracy timepiece according to claim 4, further comprising:
a power supply removal detection means for detecting removal of a power supply; and
an oscillation control means for controlling said oscillation means to stop or resume an oscillation, characterized in that
said data storage means has a memory and a power unit for holding a content of said memory.

19. A high-accuracy timepiece according to claim 18, further comprising a data holding determination means for determining whether or not data in said data storage means has been held, characterized in that said indication means indicates the result of the determination.

20. A high-accuracy timepiece according to claim 19, characterized in that:
when said oscillation control means inputs a power supply removal detection signal from said power supply removal detection means, determines whether or not the power supply has been removed, and has determined that the power supply has been removed,
a plurality of copied data of rate fast/slow data is stored in said data storage means;
said data holding determination means inputs the plurality of copied data stored in said data storage means, and determines whether or not the data in said data storage means has been held based on any one of a condition that the plurality of copied data are the same, a condition that values of the plurality of copied data are within a given range, and a condition that all the values of the plurality of copied data are 0 or 1.

21. A high-accuracy timepiece according to claim 19, characterized in that:
said oscillation control means inputs the state detection signal from said state detection means, determines what operation has been performed by the external part, and, when an operation of resuming an oscillation has been performed, controls said oscillation means to resume the oscillation and controls said data holding determination means to make a data holding determination.

22. A high-accuracy timepiece having oscillation means for outputting a timing reference signal, characterized by comprising:
a data storage means having a memory for storing rate fast/slow data and a backup power supply for supplying power for holding a content of said memory;
a power supply removal detection means for detecting removal of a power supply; and
an oscillation control means for controlling said oscillation means to stop or resume an oscillation.

23. A high-accuracy timepiece according to claim 22, characterized by further comprising:
a data holding determination means for determining whether or not data of said data storage means has been held; and
an indication means for indicating a detection result obtained by said data holding determination means.

24. A high-accuracy timepiece according to claim 23, characterized in that:
when said oscillation control means inputs the power supply removal detection signal from said power supply removal detection means, determines whether or not the power supply has been removed, and has determined that the power supply has been removed,
a plurality of copied data of rate fast/slow data is stored in said data storage means;
said data holding determination means inputs the plurality of copied data stored in said data storage means, and determines whether or not the data in said data storage means has been held based on any one of a condition that the plurality of copied data are the same, a condition that values of the plurality of copied data are within a given range, and a condition that all the values of the plurality of copied data are 0 or 1.

25. A high-accuracy timepiece according to claim 23, further comprising state detection means for detecting a state of external means which externally performs an operation of inputting the rate fast/slow data, and for outputting a state detection signal, characterized in that
said oscillation control means inputs the state detection signal from said state detection means, determines what operation has been performed by said external means, and, when an operation of resuming an oscillation has been performed, controls said oscillation means to resume the oscillation and controls said data holding determination means to make a data holding determination.
